(19) United States
(12) Patent Application Publication
(10) Pub. No.: US 2005/0188425 A1
(43) Pub. Date: Aug. 25, 2005

(54) Electronic information lockout system

(76) Inventor: Douglas Horn, Framingham, MA (US)

Correspondence Address: WOOD, HERRON & EVANS, LLP, 2700 CAREW TOWER, 441 VINE STREET, CINCINNATI, OH, 45202, US

(21) Appl. No.: 10/782,637

(22) Filed: Feb. 19, 2004

(51) Int. Cl. G06F 11/30

(52) U.S. Cl. 726/34

(57) ABSTRACT

A lockout system for preventing a person from accessing electronic information using a computer or cable/ADSL modem, the system comprising a case housing a circuit capable of accessing electronic information and a locking device including a reading device configured to receive user input, the locking device configured to enable and disable the access of electronic information in response to the user input.

### FIELD OF THE INVENTION

This invention relates generally to a system and method for preventing children from accessing parentally-restricted electronic information through their computers, and is specifically related to preventing children from accessing pornography and other undesirable information over the Internet, as well as limiting the amount of time a child has access to the Internet.

### BACKGROUND OF THE INVENTION

With the widespread access to on-line computer information and services, which continue to grow each year, collectively referred to as the Internet, computer users are able to obtain a wide variety of information which is delivered directly into their homes. All that is necessary to access the Internet is a computer with modem or interfacing capability, a telephone or asymmetric digital subscriber line (ADSL), and a telephone port or jack.

To meet the demand for Internet information, there has also been a proliferation of Internet services and access software packages which allow a user to move through or browse the available on-line options. This has made it very easy for users to obtain the information they need. Internet users are not only adults, but children as well, and ironically, children, as a class, are probably more computer literate than many adults due to the great amount of exposure to computers that children now receive at an early age. The user-friendly atmosphere of the Internet allows children with even minimal computer skills to access information at defined “sites” which are related to a particular topic.

Unfortunately, not all information sites contain material which is suitable for children. Pornographic material, for example, is abundant on the Internet, and children can access and view pornographic pictures much the same way that they might view pictures in a pornographic magazine. While access to magazines and other printed materials is limited to adults, access to Internet pornography is not so limited. As may be appreciated, child access to pornography through the Internet is an alarming concern for parents and other adults, such as educators, who do not want their own children or children in their care exposed to pornography.

Additionally, pornographic materials and sites are not the only informational avenues to which parents and other adults would like to restrict their children's access. The Internet also provides access to information regarding body piercing, child pornography, violent topics, and other similar information which would be detrimental to the proper mental and physical development of a child. Seemingly innocuous chat groups on the Internet may also expose a child to harmful adult topics. Chat groups are not only mentally dangerous to children but also physically dangerous, as evidenced by numerous incidences wherein children have been abducted by pedophiles whom they have met and talked with over the Internet.

Therefore, parents and other adults have a substantial interest in preventing children from accessing the Internet through their computers. This is becoming ever more difficult, since personal and home computers are very popular and are becoming more widespread, much the same way that television did in the 1950's and 1960's. Parents' frustrations are further exacerbated by the fact that personal computers are usually placed in a home office, bedroom, or other designated room and are not readily visible to a supervising adult. A child may be accessing parentally-restricted information right under the nose of a parent.

While censorship efforts have been made to prevent certain categories of materials from appearing on or being accessible through the Internet, they have been generally unsuccessful. Despite the possible harm to children from these materials, First Amendment arguments and concerns have prevented the removal of the above-discussed material from the Internet. Furthermore, since adults and children share the same access to such materials, widespread database prevention for children at the source will inevitably prevent adult access to information which arguably should be available to them. Therefore, parents and other adults are left with the task of preventing children from accessing certain Internet materials.

Furthermore, not only are parents and adults interested in preventing Internet access to potentially damaging and harmful materials, but they are also interested in preventing any additional Internet access at all. Internet shopping is also a concern, as companies offer numerous products for sale over the Internet which require only a credit card number. In the case of some on-line services, they may already have the parent's credit card number and all that a child has to do is make the order. There are more than a few parents that have been unpleasantly surprised by credit card bills directly related to their child's access to the Internet. Finally, a parent may simply be interested in preventing a child from spending too much time on the computer to the detriment of their school work or other activities, such as sports. For example, with the use of messaging products, children may use the Internet to chat with one another, and a parent may desire to limit such chatting.

A simple solution to preventing a child's access to the Internet would be to remove the computer and lock it away until a child may be supervised by an adult. Such a solution is not only impractical, but it is also inconvenient. Computers are usually bulky and heavy and are not easy to move around. Furthermore, the various peripherals such as printers, monitors and phone line connections will constantly have to be disconnected and then reconnected each time that the computer is to be used. Still further, removing the computer prevents adult use and non-Internet use. Computers are very useful tools and are used by adults and children alike for a number of constructive tasks such as accounting, document generation and homework. Locking the computer away prevents such constructive use. Even when the computer is to be constructively used, such as by a child for homework, most parents do not want to have to stand behind the child or even stay in the same room to prevent Internet access altogether or to prevent access to undesirable or adult materials.

One electronic information lockout device that prevents Internet access through a computer is disclosed in U.S. Pat. No. 5,661,786 (the '786 patent), held by the inventor of the present invention. Using this device, Internet access may be prevented using a keyed switch. Although the device of the '786 patent works well, a user must be proximate the device and use the key to prevent Internet access. Moreover, a user must keep track of the physical location of the key. For these reasons, improvements related to the ability of preventing Internet access without being proximate a lockout device and requiring a key are in continuing need.

One electronic information lockout system that prevents Internet access through a computer is disclosed in U.S. Pat. No. 5,938,767 (the '767 patent), also held by the inventor of the present invention. Such a system comprises a controller unit and a locking device including a key operated switch. Although the system of the '767 patent works well, again, due to the key, improvements related to the ability of preventing Internet access without being proximate a lockout device and requiring a key are in continuing need.

Therefore, it is an objective of the present invention to assist parents and other adults in preventing a child's exposure to harmful and undesirable information available on the Internet.

It is another objective of the invention to provide parents with the ability to limit the amount of time a child spends using the Internet.

It is still another objective to provide to an adult such restrictive measures without substantial modification to or removal of a computer to allow constructive use of a computer by a child.

It is another object of the invention to restrict unsupervised access to the Internet to reduce monetary costs associated therewith.

It is still another objective to provide assistance to adults in a relatively inexpensive and easily understood manner so that restrictive measures may be implemented without substantial financial or time expenditures by an adult.

It is another objective to restrict a child's access to the Internet in a way which is not easily or readily overcome or bypassed by the child.

It is still another objective to provide a parent the ability to restrict Internet access without knowing how to use a computer.

It is another objective of the present invention to provide a parent with the ability to restrict Internet access remotely.

### SUMMARY OF THE INVENTION

The above objectives and other objectives are met by the system of the present invention that may be installed in a computer, having an Ethernet or modem circuit or in a cable modem or asymmetric digital subscriber line (ADSL) modem. When installed, the system of the present invention prevents children from accessing parentally-restricted and undesirable electronic information using the computer or cable/ADSL modem. Further, the lockout system prevents exposure to undesirable information while maintaining the operational integrity of the computer so that it may be used for constructive purposes. The lockout system is also not easily or readily bypassed by a child and provides a parent or other adult the ability to restrict Internet access without themselves intimately knowing how to use a computer.

More specifically, and in one embodiment of the invention, a lockout device includes a key for enabling and disabling Internet access, a key operated switch configured to receive the key and selectively break traces providing Internet access, and a display electrically coupled to the key operated switch and configured to indicate whether Internet access is enabled or disabled.

In another embodiment of the invention, a lockout device includes a key for enabling and disabling Internet access, a relay configured to selectively break traces providing Internet access, a key operated switch electrically coupled to the relay and configured to receive the key and energize the relay, and a display electrically coupled to the relay for indicting whether Internet access is enabled or disabled.

In yet another embodiment of the invention, a lockout system includes a computer including a case and a motherboard capable of accessing electronic information mounted in the case, the case also configured for mounting a locking device and a locking device including a reading device configured to receive user input, the locking device mounted in the case, electrically coupled to the motherboard, and configured to enable and disable the access of electronic information in response to the user input.

In still another embodiment of the invention, a lockout system includes a modem including a case and a circuit capable of accessing electronic information mounted in the case, the case also configured for mounting a locking device, and a locking device including a reading device configured to receive user input, the locking device mounted in the case, electrically coupled to the circuit board, and configured to enable and disable the access of electronic information in response to the user input.

The lockout system of the invention thereby assists parents and other adults in preventing a child's exposure to harmful and undesirable on-line information and reduces or eliminates the costs that might be associated therewith. Further, the invention allows a parent to limit the amount of time a child has access to on-line information. The lockout system also does not affect the stand-alone operational capability of a computer or cable/ADSL modem. The lockout system may be installed by an original equipment manufacturer (OEM), potentially eliminating the need for user installation. Furthermore, the lockout system does not require the adult to be able to operate the computer. The lockout system is not easily or readily overcome or bypassed by the child.

The objectives and benefits of the present invention will become more readily apparent from the brief description of the drawings and detailed description of the invention given below.

### BRIEF DESCRIPTION OF THE DRAWINGS

The accompanying drawings, which are incorporated in and constitute a part of this specification, illustrate embodiments of the invention and, together with a general description of the invention given below, serve to explain the principles of the invention.

FIG. 1 is a block diagram of one embodiment of the present invention installed in a personal computer;

FIG. 1A is a detailed schematic view of the relay of FIG. 1;

FIG. 2 is a block diagram of one embodiment of the present invention installed in a cable/ADSL modem;

FIG. 2A is a detailed schematic view of the relay of FIG. 2;

FIG. 3 is a block diagram for a lockout system including a reading device and a display;

FIG. 4 is a flowchart illustrating the program flow of a process of authenticating and authorizing a user in the lockout system of FIG. 3;

FIG. 5 is a block diagram for a lockout system including a reading device, a display, and an interactive telephone component;

FIG. 6 is a flowchart illustrating the program flow of a process of verifying a user and enabling/disabling Internet access using interactive telephone component of the lockout system of FIG. 5;

FIG. 7 is a block diagram for a lockout system including a reading device, a display, and a web-based interface; and,

FIG. 8 is a flowchart illustrating the program flow of a process of verifying a user and enabling/disabling Internet access using a web-based device of the lockout system of FIG. 7 is illustrated.

### DETAILED DESCRIPTION OF THE INVENTION

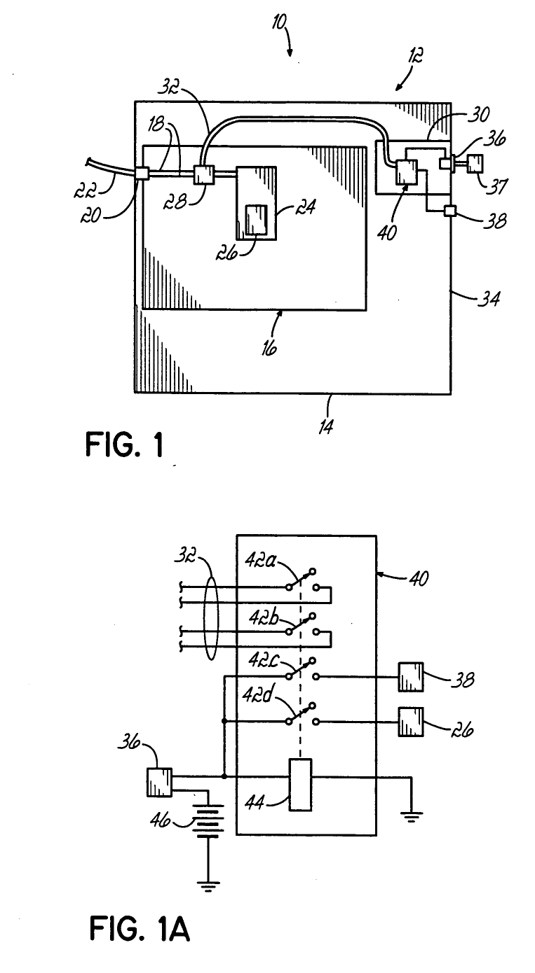

FIG. 1 illustrates, in block diagram form, one embodiment 10 of the present invention installed or mounted in a personal computer (PC), or simply a computer 12. As illustrated, the side cover of computer 12 has been removed so that the interior of computer 12 is visible. Specifically, computer 12 comprises a case 14 and a circuit board or motherboard 16. As is common practice, etched or otherwise deposited on motherboard 16 are conductive traces, a portion of which are indicated at reference numeral 18. As will be appreciated by those of ordinary skill in the art, Internet access is often provided using two electrical conductors or a pair of conductors, and thus conductive traces 18 represent such a pair of conductors. In some embodiments a lesser or greater number of conductors may be used to provide Internet access, and some or all such conductors may be interrupted. Those of ordinary skill in the art will appreciate that government bodies or regulatory agencies may mandate the number of conductors used, as well as how such conductors may be controlled. Such a use of a lesser or greater number of conductors does not constitute a departure from the spirit of the present invention.

Internet access may also be provided in a wireless fashion. Such a use of a wireless interconnection also does not constitute a departure from the spirit of the present invention.

Various components are soldered to the traces on motherboard 16 thereby forming circuits that perform a variety of functions, including providing Internet access. For example, and as illustrated in the embodiment of FIG. 1, one such circuit 24 is an Ethernet circuit 24. Ethernet circuit 24 functions as an Ethernet port and may be used for Internet access as will be described. To control the provision of Internet access, Ethernet circuit 24 may include a microprocessor or controller 26 which is operable for controlling the various features of Ethernet circuit 24, such as the transmission and receipt of data.

In another embodiment of the present invention, the circuit 24 may be a modem circuit used for Internet access. Such a modem circuit may also include a microprocessor or controller 26 to control the provision of Internet access. Similar to an Ethernet circuit, a modem circuit may also electrically couple with traces 18. The use of a modem circuit also does not constitute a departure from the spirit of the present invention.

Moreover, irrespective of whether an Ethernet or a modem circuit is use, such circuits 24 may be implemented on a separate circuit board, or as an expansion card, rather than incorporated onto a motherboard, such as the way Ethernet circuit 24 is incorporated onto motherboard 16. Expansion cards may be plugged into slots or connectors electrically coupling the cards to a bus on the motherboard to make available to the motherboard the functionality of the cards. Implementing an Ethernet or a modem circuit on a separate circuit board also does not constitute a departure from the present invention.

Turning more specifically to motherboard 16, circuit 24 is electrically coupled to traces 18. Also electrically coupled to traces 18 is a jack such as Ethernet jack 20. Inserted into Ethernet jack 20 is a cable such as an Ethernet cable 22. Thus, Ethernet circuit 24 is electrically coupled to an Ethernet connection through traces 18, Ethernet jack 20, and Ethernet cable 22 for purposes of providing Internet access.

Also coupled to traces 18 intermediate Ethernet circuit 24 and Ethernet jack 20 is a connector 28. Connector 28 is configured such that traces 18 are electrically broken or the conductivity of the traces is interrupted. As illustrated, a locking device 30 may be connected to connector 28 using a cable 32. Cable 32 includes four conductors for this purpose. Locking device 30 is configured to selectively break traces 18 when electrically coupled to the traces through connector 28 such that Internet access is enabled or disabled, or, in other words, the access to electronic information through traces 18 and cable 22 is enabled or disabled. In some embodiments of the present invention such a connector may not be required though similar functionality is achieved, such as when cable 22 is directly physically connected to traces 18.

Locking device 30 is preferably mounted to the front 34 of case 14, as shown in FIG. 1, providing ready user access. Locking device 30 comprises a key operated switch 36, a light emitting diode (LED) display 38, and a relay 40. More specifically, locking device 30 is mounted such that a key 37 may be inserted into key operated switch 36 by a user, while LED display 38 is mounted such that it may be readily observed by a user.

In other embodiments of the present invention, some or all of the components of a locking device may be integrated onto a motherboard as desired.

As schematically illustrated in FIG. 1A, relay 40 includes four poles or switch contacts 42a-d and a coil 44 that may be energized to actuate the switch contacts 42a-d. Two of the switch contacts 42a, 42b are respectively electrically coupled to traces 18 through cable 32, while a third switch contact 42c is electrically coupled to LED display 38. A fourth switch contact 42d may be electrically coupled to controller 26 for an additional or alternative means of enabling/disabling Internet access. Coil 44 of relay 40 is electrically coupled to key operated switch 36 and to a power source from computer 12. In the alternative, a power source may be derived from a battery 46.

Referring to FIGS. 1 and 1A, and in use, a user inserts key 37 into key operated switch 36 and turns the key to selectively enable or disable Internet access. For example, when key operated switch 36 is in the position that disables Internet access, coil 44 of relay 40 is de-energized and contacts 42a-d remain in the normally open position, contacts 42a, 42b breaking traces 18. Further, contact 42c remains in the normally open position such that LED display 38 is extinguished.

However, once key 37 is rotated such that key operated switch 36 is in the position that enables Internet access, coil 44 of relay 40 is energized by battery 46 and contacts 42a-d are closed, contacts 42a, 42b coupling circuit 24 to an Ethernet connection or a telephone line connection. Further, contact 42c is also closed such that battery 46 illuminates LED display 38.

As an alternative to, or in addition to, selectively breaking traces 18 such that Internet access is enabled or disabled, the present invention may provide a signal to a controller for purposes of enabling or disabling Internet access. For example, and as shown in FIG. 1A, contact 42d is used to provide a high logic level to controller 26 using battery 46 when Internet access is enabled. Similarly, a pull down resistor (not shown) connected to ground may be used to provide a low logic level when Internet access is disabled. Controller 26 may be programmed to sense a logic level and enable/disable Internet access in response thereto.

In other embodiments of the present invention, a locking device may comprise a key operated switch directly electrically coupled and configured to selectively break traces or provide a logic level to a controller using a key for purposes of enabling/disabling Internet access and a display for indicting whether Internet access is enabled or disabled. Such a concept uses key operated switches having numerous poles, each of which may be used to break a respective trace, illuminate/extinguish a display, and signal a controller. Key operated switches having numerous poles may, in fact, be obtained, though the cost of such key operated switches may exceed a single pole switch cost. Nonetheless, the present invention contemplates and encompasses these embodiments.

With respect to FIG. 1, when it is not desirous to include a locking device in computer 12, jumpers (not shown) may be used for connector 28 thereby allowing the use of computer 12 without the benefit of locking system 10. Thus, a computer, such as computer 12, may be produced by an original equipment manufacturer (OEM) configured for the inclusion of a locking device, but without a locking device installed.

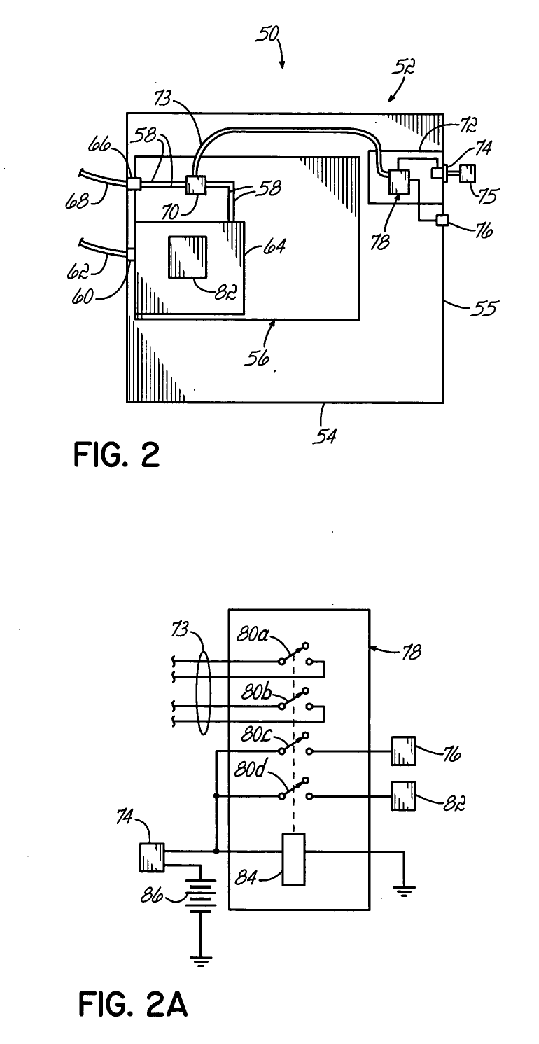

Referring now to FIG. 2, an embodiment 50 of the present invention installed or mounted in a cable or asymmetric digital subscriber line (ADSL) modem 52 is shown in block diagram form. Cable/ADSL modems are commonly used to provide high speed Internet access available from a local telephone company or through a local cable television or satellite provider. Those of ordinary skill in the art will appreciate that the lockout system of the present invention may be used with technologies such as web TV, televisions and cable boxes with Internet capabilities or other computer systems capable of providing on-line services.

As illustrated, the cover of cable/ADSL modem 52 has been removed so that the interior of modem 52 is visible. Generally, modem 52 comprises an enclosure 54 in which a circuit board 56 is mounted. As is common practice, etched or otherwise deposit on circuit board 56 are conductive traces, a portion of which are shown at reference numeral 58. Electrical components are soldered to the traces to form a circuit or circuits 64 used to provide Internet access. For example, circuit 64 may include a microprocessor or controller 82 to control the provision of Internet access.

Two of the electrical components soldered to the traces are connectors 60 and 66. For example, and in one embodiment, connector 60 may be configured to receive a multiconductor cable as is commonly used by local telephone companies in providing an ADSL connection for high speed Internet access, and in which case cable 62 is a multiconductor cable. In another embodiment, connector 60 may be configured to receive a coaxial cable as is commonly used by local cable television or satellite providers in providing high speed Internet service, and in which case cable 62 is a coaxial cable.

Similarly, connector 66 in one embodiment may be configured to receive a multiconductor cable as is commonly used to provide an Ethernet connection to computer or router (not shown). In another embodiment, connector 66 may be configured to receive a multiconductor cable as is commonly used to provide a uniform serial interface bus (USB) connection to a computer or router. Such cables are represented at reference numeral 68.

The lockout system of the present invention may be used with cable/ADSL modems including those having a router or routing capabilities. Generally, a router is used to provide Internet access to multiple computers, for example. In such an embodiment, one or more of the ports of the router may be disabled using the present invention to interrupt or suspend Internet access to a respective computer.

More specifically, and with respect to circuit 64, circuit 64 is electrically coupled to traces 58. Also electrically coupled to traces 58 is connector 66. Electrically coupled intermediate circuit 64 and connector 66 is a connector 70. Similar to connector 28 in FIG. 1, connector 70 is configured such that traces 58 are electrically broken.

As illustrated in FIG. 2, locking device 72 may be connected to connector 70 using a cable 73. When locking device 72 is connected to connector 70 using cable 73, locking device 72 is coupled in-line with traces 58 by connector 70. Cable 73 includes four conductors for this purpose. Locking device 72 is configured to selectively break traces 58 when electrically coupled to the traces through connector 70 such that Internet access is enabled or disabled.

Locking device 72 comprises a key operated switch 74, an LED display 76, and a relay 78. Locking device 72 is generally mounted toward the front 55 of enclosure 54 to provide ready user access. More specifically, locking device 72 is mounted such that a key 75 may be inserted into key operated switch 74 and such that LED display 76 is visible. In other embodiments of the present invention, some or all of the components of a locking device may be integrated onto circuit board 56 as desired, while still providing user interaction.

As schematically illustrated in FIG. 2A, relay 78 includes four poles or switch contacts 80a-d and a coil 84 to actuate the switch contacts 80a-d. Switch contacts 80a and 80b are respectively electrically coupled to traces 58 through cable 73. Switch contact 80c is electrically coupled to LED display 76 and switch contact 80d may be electrically coupled to controller 82. Coil 84 of relay 78 is electrically coupled to key operated switch 74 and to a power source from cable/ADSL modem 52. As an alternative to power derived from a cable/ADSL modem 52, power may be derived from a battery 86.

Referring to FIGS. 2 and 2A, a user inserts key 75 into key operated switch 74 and turns the key to selectively enable or disable Internet access. As illustrated, when key operated switch 74 is in the position that disables Internet access, coil 84 is de-energized and contacts 80a-d remain in the normally open position, contacts 80a, 80b breaking traces 58 via cable 73. Similarly, contact 80c remains in the normally open position such that LED display 76 is extinguished.

However, when key 75 is turned so that key operated switch 76 is in the position that enables Internet access, coil 84 is energized by battery 86 and contacts 80a-d are closed. Contacts 80a, 80b then couple circuit 64 to a computer or router (not shown). In addition, contact 80c allows battery 86 to illuminate LED display 76.

As an alternative to, or in addition to, selectively breaking traces 58 to enable or disable Internet access, a locking device may provide a signal to a controller for purposes of enabling or disabling Internet access. For example, and as shown in FIG. 2A, contact 80d is used to provide a high logic level to controller 82 using battery 86 when Internet access is enabled. A pull down resistor (not shown) may be used to provide a low logic level when Internet access is disabled. Controller 82 may be programmed to sense a logic level and enable/disable Internet access in response thereto.

Still referring to FIG. 2, when it is not desirous to include a locking device in cable/ADSL modem 52, jumpers (not shown) may be used for connector 70 thereby allowing cable/ADSL modem 52 to be used without the benefit of locking system 50. Thus, a cable/ADSL modem may be produced by an OEM and configured for the inclusion of a locking device, but without a locking device installed.

Lockout systems 10 and 50 of the invention, shown in FIGS. 1 and 2, respectively, provide Internet locking devices 30, 72 that may be integrated into a computer or a cable/ADSL modem. Locking devices 30, 72 may be actuated and deactuated, or locked and unlocked, as necessary to prevent Internet access or to provide adult supervised access. Lockout systems installed in a computer or a cable/ADSL modem provide enhanced security over systems that are external to a computer or modem. Further, since lockout systems 10 and 50 are generally installed by OEMs rather than users, such lockout system may be thought of as easier to use by users, requiring no installation. Finally, since lockout systems 10 and 50 are installed by OEMs, such systems are generally more economical for users.

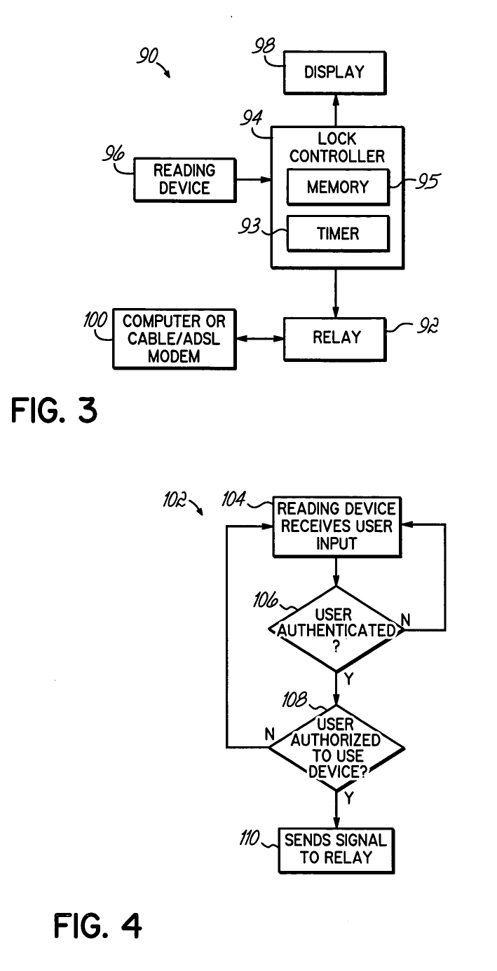

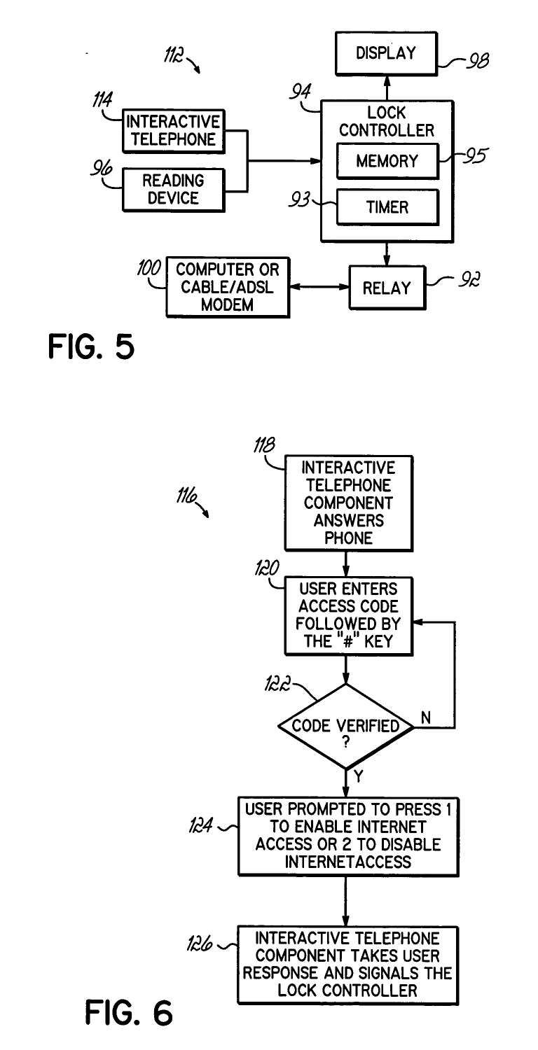

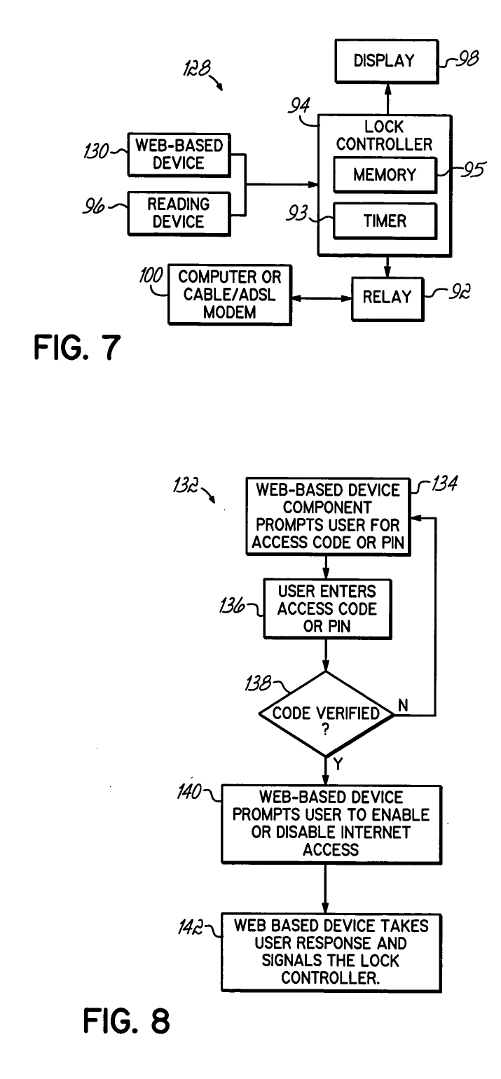

The remaining embodiments of the present invention, shown in FIGS. 3-8, and described herein after, include various features described in conjunction with lockout systems 10 and 50 shown in FIGS. 1 and 2. Moreover, the embodiments shown in FIGS. 3-8 provide additional or alternative features with still further benefits. For example, FIG. 3 shows a block diagram for a lockout system including a reading device and a display, while FIGS. 5 and 7 show a block diagram for two embodiments of lockout systems including an interactive telephone component and a web-based device, respectively.

Referring now to FIG. 3, a block diagram for lockout system 90 is illustrated. Lockout system 90 comprises a relay 92, a lock controller 94, a reading device 96, and a display 98. Relay 92, lock controller 94, reading device 96, and display 98 may be mounted in a computer or a cable/ADSL modem, such as in computer 12 shown in FIG. 1 or cable/ADSL modem 52 shown in FIG. 2.

As described above, relay 92 is coupled to a motherboard in a computer or a circuit board in a cable ADSL modem, as indicated at reference numeral 100, and configured to enable/disable Internet access. Again, lockout system 90 may be manufactured as one unit and mounted inside a computer case or a cable/ADSL modem enclosure or integrated onto a circuit board or motherboard.

Generally, relay 92 is coupled to and controlled by lock controller 94. Lock controller 94 energizes/de-energizes relay 92 in response to reading device 96. The Internet status, or whether Internet access is enabled/disabled, is indicated by display 98.

A reading device 96 may be any one of many reading devices. For example, a reading device may be a magnetic card reader, a numeric or alphanumeric keypad, a keyboard, a touch screen, a fingerprint or retinal scanner, or a voice or facial recognition device. A reading device is generally used to authenticate, or provide a user identity, and grant Internet access based thereon.

Lock controller 94 includes a processor, or microprocessor, preferably including a timer 93 and memory 95. In addition to controlling relay 92, lock controller 94 is configured to store authentication information, e.g., magnetic card personal identification numbers (PINs), images of finger prints, etc., using included memory 95, to which information presented through reading device 96 is then compared. Lock controller may be further configured to assign temporary authentication for a fixed amount of time using included timer 93. For example, a babysitter could be assigned a temporary access code for the night that the babysitter is to watch a child, thereby limiting access to the Internet for that particular evening. Moreover, timer 93 provides the ability to limit the amount of time that a child has access to the Internet. For example, lockout device 90 may limit one child's Internet access to one hour per day, while limiting another child to two hours per day. Timer 93 may also be used to provide Internet access only during specified times during weekdays, while providing different access times during weekends. For example, Internet access may be enabled between the hours of 7:00 pm and 8:30 pm, Monday through Friday, and 9:00 am and 11:00 am, Saturday and Sunday. Other uses of a timer for enabling Internet access may also be implemented.

A processor may be replaced with specialized circuitry capable of performing like tasks. Despite incurring time and expense, such a replacement would not constitute a departure from the spirit of the present invention.

Display 98 in its simplest form may utilize indicator lights or LEDs. An indicator light or LED may be coupled to lock controller 94 and illuminated to indicated whether Internet access is enabled or disabled. In other embodiments of the invention a display may be a liquid crystal display (LCD). In still other embodiments of the invention a display may be a video screen, such as those commonly used in cellular telephones. In addition to indicating whether Internet access is enabled or disabled, a LCD and a video screen are particularly advantageous in a lockout system 90 in setting the system to limit access to the Internet based on user, time, day of week, etc., as described herein above.

In operation, a person or user wishing to enable access to the Internet would interact with reading device 96, entering a PIN through a keypad, passing an access card through a magnetic card reader, etc. The reading device 96 then passes information, e.g., PIN, magnetic code, etc., to lock controller 94. Lock controller 94 then authenticates the user. Next, lock controller 94 authorizes the user. If the user is authenticated and authorized, lock controller 94 either energizes or de-energizes relay 92 to either enable or disable Internet access. Lock controller 94 then displays whether the Internet is enabled or disabled on display 98.

Referring now to FIG. 4, a flowchart illustrating the program flow of a process of authenticating and authorizing a user in the lockout system of FIG. 3 is illustrated. Process 102 begins in step 104 wherein a user enters a PIN through a keypad, passes an access card through a magnetic card reader, etc. using reading device 96. This PIN, magnetic code, etc., is compared or verified against information stored in memory 95 by lock controller 94 to authenticate or identify the user in step 106. If the user is authenticated, step 108 is entered. Otherwise, control is returned to step 104, and the process awaits further entry from a user while display 98 indicates an authenticating and/or authorizing failure to the user.

In step 108, lock controller 94 makes a comparison against information stored in memory 95 to ascertain whether the authenticated user is authorized at the current time, such as by using timer 93. For example, if a user is a parent, the parent might be authorized to use the Internet at all times. However, if the authenticated user is a child, there may be some time restriction or limits on Internet access.

Once, the user is authorized and authenticated, lock controller 94 sends a signal to relay 92 to enable or disable Internet access, in step 110. In some embodiments of the present invention, a display may also be updated in this step to indicate whether the Internet is enabled or disabled. However, if at the current time, the user is not authorized, control is returned to step 104 until such time as the user is authorized.

As another example, a lockout system may comprise a keypad. A parent might enter a master code using the keypad, assigning a new code to a babysitter, authorizing that code, or the babysitter for some time period, such as the evening the babysitter is to watch a child. In this example, the babysitter would enter the new code via the keypad to use the Internet, and only be able to use the Internet during the evening the babysitter is to watch the child.

As yet another example, a lockout system may comprise a video display, wherein a lock controller 94 is configured to display menu-driven options thereon. Such a video display has the benefit of allowing additional information to be provided to a user. For example, if a child is only allowed to use the Internet for one hour each day, the video display may indicate to the child the time that they have remaining to use the Internet.

Thus, process 102 provides a way of authenticating and authorizing a user of a lockout system.

Referring now to FIG. 5, a block diagram for lockout system 112 is illustrated. Like lockout system 90, shown in FIG. 3, lockout system 112 comprises relay 92, lock controller 94, reading device 96, and display 98. Further, lockout system 112 operates in a generally similar manner as lockout system 90, relay 92 being coupled to a computer or cable/ADSL modem 100, and configured to enable/disable Internet access.

Lockout system 112 further comprises an interactive telephone component 114. A telephone line may need to be provided for interactive telephone component 114. Interactive telephone component 114 allows a user to control lockout system 112 remotely over a telephone line, such as one available through cable 22 shown in FIG. 1. Further, interactive telephone component 114 allows a user to access lockout system 112 in much the same way one typically accesses an interactive telephone voice mail system. Generally, interactive telephone component prompts a user to enter an access or PIN code via a telephone keypad. Once the access code is verified, the user may then program lockout device 112 through a menu-driven system similar to most interactive telephone response systems, including enabling/disabling Internet access.

Referring now to FIG. 6, a flowchart illustrating the program flow of a process of verifying a user and enabling/disabling Internet access using interactive telephone component 114 of lockout system 112 of FIG. 5 is illustrated. Process 116 begins in step 118 wherein a user dials interactive telephone component 114 and the interactive telephone component answers the call.

Next, in step 120, interactive telephone component 114 prompts the user to enter an access code or PIN, followed by, for example, the “#” key. In step 122, interactive telephone component 114 verifies the access code through lock controller 94, through a comparison with information stored in memory 95. If the access code is verified, control is passed to step 124. Otherwise, control is returned to step 120, and the user is again prompted to enter an access code.

In step 124, the user is prompted to press “1” to enable Internet access or “2” to disable Internet access. In step 126, based on this selection of “1” or “2,” interactive telephone component 114 signals lock controller 94 to indicate to the lock controller whether to enable or disable Internet access using relay 92.

Thus, process 116 provides a way of remotely enabling/disabling Internet access using a lockout system and a telephone. An interactive telephone component may use voice-prompting as an alternative to key-entry, and such a use does not constitute a departure from the spirit of the present invention. Further, a similar process may be used to remotely enable/disable Internet access based upon times, or to set up timed access. It will also be appreciated that such a process may be executed by lock controller, such as lock controller 94, rather than an interactive telephone component, and that such an incorporation also does not constitute a departure from the spirit of the present invention. A similar process may be used to select other menu selections and/or settings, such as will be described herein after.

Referring now to FIG. 7, a block diagram for lockout system 128 is illustrated. Like lockout systems 90 and 112, shown in FIGS. 3 and 5, respectively, lockout system 128 comprises relay 92, lock controller 94, reading device 96, and display 98. Further, lockout system 128 is configured like and operates generally similar to lockout systems 90 and 112, relay 92 being coupled to a computer or a cable ADSL modem 100, and configured to enable/disable Internet access.

Lockout system 128 further comprises a web-based device 130. Web-based device 130 provides a user the ability to configure lockout device 128 using an Internet browser, e.g., Microsoft Internet Explorer, Netscape Navigator, etc., either remotely or locally by entering the uniform resource locator (URL) or IP address of the lockout system. In a network, an additional network connection may need to be provided to web-based device 130.

Even though an Internet or web browser is suggested by this embodiment, a lockout system may also be locally or remotely accessed over a network using other technologies. In such a networked application, a user may enter the network address for the lockout system. For example, in a “smart home,” a remote touch pad may allow a user to configure a lockout device. Similarly, an application on a computer or wireless device, such a cellular phone, palm, hand-held computer, etc., may allow a user to configure a lockout device.

For example, lockout device 128 may be configured locally using a computer through which that computer is coupled to the Internet, such as using computer 12 shown in FIG. 1. Alternatively, lockout device 128 may be accessed and configured through a network or Internet connection using some computer remote to lockout system 128.

Irrespectively of whether lockout system 128 is accessed and configured locally or remotely, a user would see a web-like screen on the browser used that would allow them to configure lock controller 94 or system 128. A network may be either wired or wireless.

Referring now to FIG. 8, a flowchart illustrating the program flow of a process of verifying a user and enabling/disabling Internet access using web-based device 130 of lockout system 128 of FIG. 7 is illustrated. Process 132 begins in step 134 wherein a user enters the network address of the lockout system using an Internet browser and a web-like screen appears to prompt the user to enter an access code or PIN. Next, and as reflected in step 136, the user enters the access code or PIN, perhaps also entering a carriage return or pressing a login button.

Next, in step 138, web-based device 130 verifies the access code through lock controller 94, through a comparison with information stored in memory 95. If the access code is verified, control is passed to step 140. Otherwise, control is returned to step 134, and the user is again prompted to enter an access code.

In step 140, web-based device 130 prompts the user to enable or disable Internet access. In step 142, and based on a selection by the user, web-based device 130 signals lock controller 94 to either enable or disable Internet access using relay 92, based on the user selection.

Thus, process 132 provides a way of locally or remotely configuring a lockout system to enable/disable Internet access using a web-based interface. In other embodiments of the present invention, such a process may also be incorporated into a lock controller, such as lock controller 94, shown in FIG. 7.

Similar programming may be used such that a local or remote user may set timer information. For example, the user may enter start and stop times for enabling Internet access or assign PINs, etc.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A lockout device for preventing a person from accessing electronic information comprising:
a key for enabling and disabling Internet access;
a key operated switch configured to receive the key and selectively break traces providing Internet access;
a display electrically coupled to the key operated switch and configured to indicting whether Internet access is enabled or disabled.

2. The lockout device of claim 1, wherein the display includes a light emitting diode (LED).

3. The lockout device of claim 1, wherein the lockout device is configured for mounting in a case of one of a computer, a cable modem, and an asymmetric digital subscriber line (ADSL) modem.

4. A lock out device for preventing a person from accessing electronic information comprising:
a key for enabling and disabling Internet access;
a relay configured to selectively break traces providing Internet access;
a key operated switch electrically coupled the relay and configured to receive the key and energize the relay;
a display electrically coupled to the relay for indicting whether Internet access is enabled or disabled.

5. The lockout device of claim 4, wherein the display includes a light emitting diode (LED).

6. The lockout device of claim 4, wherein the lockout device is configured for mounting in the case of one of a computer, a cable modem, and an asymmetric digital subscriber line (ADSL) modem.

7. A lockout system for preventing a person from accessing electronic information comprising:
a computer including a case and a motherboard capable of accessing electronic information mounted in the case, the case also configured for mounting a locking device;
a locking device including a reading device configured to receive user input, the locking device mounted in the case, electrically coupled to the motherboard, and configured to enable and disable the access of electronic information in response to the user input.

8. The lockout system of claim 7, wherein the locking device further includes a display configured to indicated whether the access of electronic information is enabled or disabled.

9. The lockout system of claim 7, wherein the motherboard of the computer includes traces that carrying the electronic information.

10. The lockout system of claim 7, wherein the locking device further includes a relay electrically coupled to the motherboard and configured to enable and disable the access of electronic information.

11. The lockout system of claim 7, wherein the reading device is a magnetic card reader.

12. The lockout system of claim 7, wherein the reading device is a keypad.

13. The lockout system of claim 7, wherein the reading device is a touch screen.

14. The lockout system of claim 7, wherein the reading device includes an interactive telephone component configured to allow the user to enable and disable the access of electronic information remotely.

15. The lockout system of claim 7, wherein the reading device includes a web-based device configured to allow the user to enable and disable the access of electronic information remotely.

16. The lockout system of claim 7, wherein the motherboard includes a controller configure to provide access to electronic information, the locking device configured to provide a signal to the controller to enable and disable the access of electronic information.

17. A lockout system for preventing a person from accessing electronic information comprising:
a modem including a case and a circuit capable of accessing electronic information mounted in the case, the case also configured for mounting a locking device;
a locking device including a reading device configured to receive user input, the locking device mounted in the case, electrically coupled to the circuit, and configured to enable and disable the access of electronic information in response to the user input.

18. The lockout system of claim 17, wherein the locking device further includes a display configured to indicate whether the access of electronic information is enabled or disabled.

19. The lockout system of claim 17, wherein the circuit of the modem includes traces that carry the electronic information.

20. The lockout system of claim 17, wherein the locking device further includes a relay electrically coupled to the circuit and configured to enable and disable the access of electronic information.

21. The lockout system of claim 17, wherein the reading device is a magnetic card reader.

22. The lockout system of claim 17, wherein the reading device is a keypad.

23. The lockout system of claim 17, wherein the reading device is a touch screen.

24. The lockout system of claim 17, wherein the reading device includes an interactive telephone component configured to allow the user to enable and disable the access of electronic information remotely.

25. The lockout system of claim 17, wherein the reading device includes a web-based device configured to allow the user to enable and disable the access of electronic information remotely.

26. The lockout system of claim 17, wherein the circuit includes a controller configure to provide access to electronic information, the locking device configured to provide a signal to the controller to enable and disable the access of electronic information.
